(19) United States
(12) Patent Application Publication
(10) Pub. No.: US 2008/0006213 A1
(43) Pub. Date: Jan. 10, 2008

(54) ANIMAL BEDDING MATERIAL AND METHOD FOR MAKING SAME

(75) Inventor: Kevin J. Hayward, Hanover, PA (US)

Correspondence Address: MCNEES WALLACE & NURICK LLC, 100 PINE STREET, P.O. BOX 1166, HARRISBURG, PA, 17108-1166, US

(73) Assignee: OX PAPER TUBE AND CORE, INC., Hanover, PA (US)

(21) Appl. No.: 11/428,750

(22) Filed: Jul. 5, 2006

(51) Int. Cl. A01K 29/00

(52) U.S. Cl. 119/172

(57) ABSTRACT

An absorbent animal bedding material includes nonfluted multilayer paperboard. The paperboard material is highly absorbent, resistant to compaction, resists clumping after being subjected to animal waste, is inexpensive and increases feed animal conversion rate.

### FIELD OF THE INVENTION

The present invention is directed to animal bedding material and method for making the same, and more specifically, to animal bedding material including an amount of multilayer, nonfluted paperboard.

### BACKGROUND OF THE INVENTION

A reliable and economical supply of animal bedding materials for organic waste management and disposal purposes is required for those engaged in animal husbandry. Bedding materials for such purposes typically include shredded paper, straw, wood shavings, sawdust and sand. The selection criteria of a material for use as animal bedding includes liquid absorbency properties (or as in the cases of sand and straw its drainage properties), availability at an economical cost, ability to minimize insect attraction and organic odors, manageability from installation to disposal, and compostability.

Paper, such as scrap newspaper and corrugated or fluted paper, are commonly used for the purpose of containing and handling organic waste in animal management operations. However, there are drawbacks associated with the use of scrap newspaper and corrugated or fluted paper.

For example, scrap newspaper and corrugated paper have a tendency to become compacted, i.e., flattened, after being trod upon by the animals. In addition, scrap newspaper tends to clump together when subjected to moisture contained in liquid and/or solid waste produced by the animals. Further problems associated with scrap newspaper can be attributed to the relatively long and narrow paper strips produced by shredding processes, which when employing conventional document shredders or the like, inherently generate strips of this form. These long and slender strips of paper have a great propensity for becoming wrapped about an animal's legs and subsequently dragged out of confines of the stall areas. Such strips also have an increased likelihood of becoming entangled in the moving parts of machinery used to handle the bedding material or becoming blown about the farm to festoon fences and trees. Further, where located adjacent inhabited areas, the paper, often containing animal waste, becomes windblown litter that can become affixed to dwelling structures or vehicles, becoming a nuisance, and of more concern, a public health issue. In addition, in at least the poultry industry, scrap newspaper soiled by waste produced by the birds can adhere to the foot pads of the birds, causing the formation of sores or bums, due to decay of the waste matter that is in contact with the birds' feet.

What is needed is animal bedding material that is absorbent, resists compaction and clumping, is economical to produce and is environmentally friendly.

### SUMMARY OF THE INVENTION

The present invention relates to an absorbent animal bedding material, including nonfluted multilayer paperboard that is resistant to compaction.

The present invention further relates to a method of manufacturing fertilizer. The steps include distributing a predetermined amount of absorbent animal bedding material over a floor of an animal holding structure for habitation by at least one animal. The bedding material includes an amount of nonfluted multilayer paperboard that is resistant to compaction. The method further includes the step of collecting the bedding material after a predetermined time period after the bedding material has been subjected to waste produced by the at least one animal.

The present invention further relates to a method of producing absorbent animal bedding material. The steps include providing an amount of nonfluted multilayer paperboard and shredding the paperboard shredding the paperboard, the paperboard being resistant to compaction.

An advantage of the present invention is it resists compression.

A further advantage of the present invention is that it is highly absorbent.

A still further advantage of the present invention is that it resists clumping.

Another advantage of the present invention is that it is inexpensive to produce.

A further advantage of the present invention is that it is that it can be disposed of in an environmentally friendly manner.

An additional advantage of the present invention is that its use results in increased weight gain for food animals, by virtue of decreased stress on the animals, resulting in increased feeding.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is an elevation view of a nonfluted structural member for use as animal bedding material of the present invention.

FIG. 2 is an elevation view of an alternate construction of a nonfluted structural member for use as animal bedding material of the present invention.

FIG. 3 is a diagram of a system for producing animal bedding material of the present invention.

FIG. 4 is a view of shredded animal bedding material of the present invention.

Wherever possible, the same reference numbers will be used throughout the drawings to refer to the same or like parts.

### DETAILED DESCRIPTION OF THE INVENTION

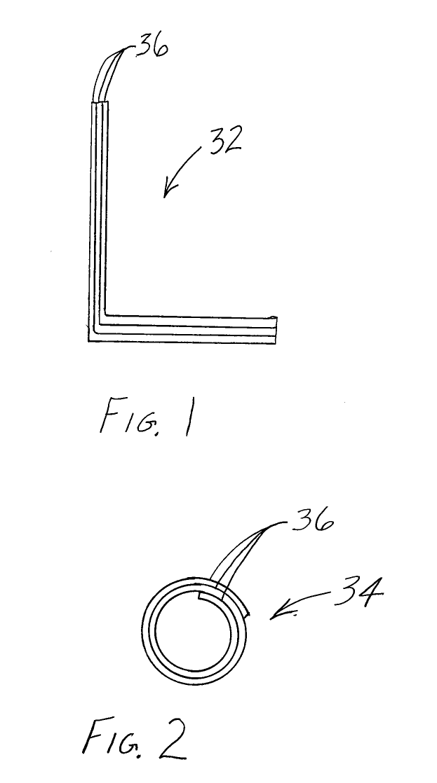

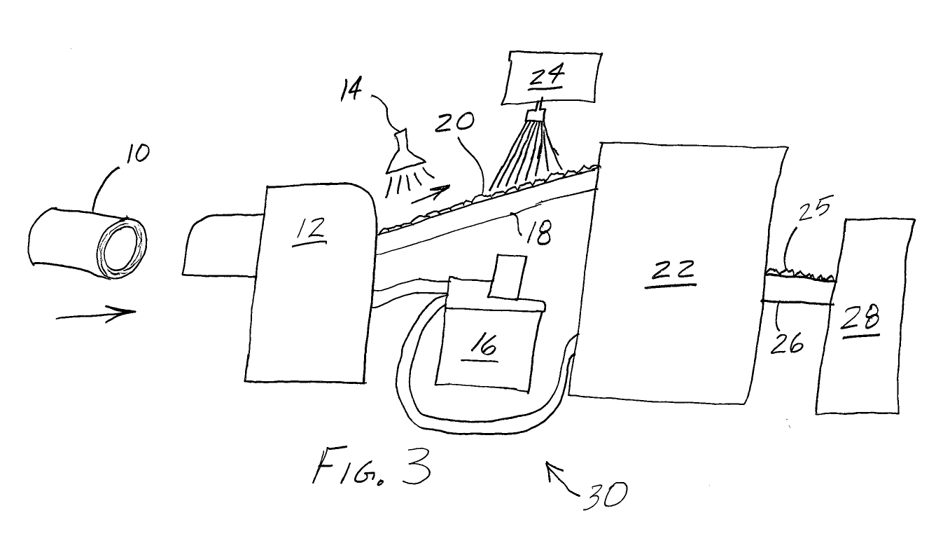

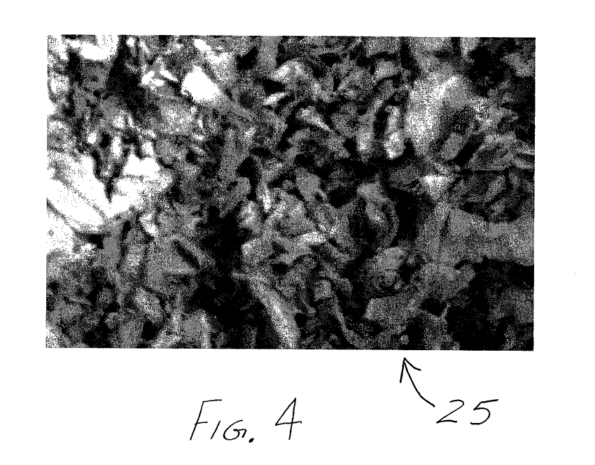

The present invention is directed to using components constructed of nonfluted multilayer paperboard 10 as shown in FIG. 3 to produce animal bedding material. The term “nonfluted” or “noncorrugated” is used herein to distinguish from corrugated material commonly used for packaging articles which are typically fluted and/or corrugated. Further, the term “multilayer paperboard” may be used interchangeably with “nonfluted multilayer paperboard” or “noncorrugated multilayer paperboard”. In other words, the multilayer paperboard material of the present invention is directed to structural members having arranged layers substantially lacking spacing therebetween. For example, layers 36 can be stacked, as shown in FIG. 1 for an angle member 32. Alternatively, layers 36 can be wound, as shown in FIG. 2 for a tube member 34. The adjacent layers are adhered together, producing structural members having a high level of strength and stiffness. The term “tube” as used herein includes cylindrical or multilayer paperboard products having other cross sectional profiles. Tubes are intended to also include such structural tubular (or other cross sectional profile) members having substantial wall thickness, which are typically referred to as “cores.” Most paperboard tubes (and cores) are used for various purposes including shipping and mailing containers, concrete forms, packing or spacers for packaging, or carriers for other materials produced in paper mills, plastic film, textiles, tape and labels, metal sheet or any other materials used in the converting process of one product to another.

In the paperboard tube fabrication process, there is a certain amount of waste due to production of either inferior product or from trimming that is generally compacted and returned to the paper mill to be re-pulped and again made into paperboard. The paperboard tube typically contains at least a portion of recycled material, which reduces its cost. However, the paperboard used to fabricate tubes (or core) is discarded after it has served its intended use and is either recycled into paper form or placed in a landfill.

The paperboard typically used for tubes is preferably recycled, both for environmental and cost reasons, over virgin fiber. However, there may be a limit to the number of times that paperboard materials can be recycled, due to hornification. Hornification refers to a complex change in the physicochemical properties of the fiber surface and the state of boundary molecules adjacent the fiber surface. While not wishing to be bound by theory, as a result of hornification, the longer (chemical pulp) fibers are understood to either be shortened, or at least, if the fibers are not shortened, the bonding ability between fibers and the flexibility of the fibers are reduced. In other words, the paperboard formed after subsequent recycling is of reduced strength, so that virgin pulp may need to be added to achieve the desired strength properties. The quality and strength of paper required for use as newspaper are considerably lower than paper used for making paperboard tubes. However, it is to be understood that the present invention does not make specific distinctions between the quality/strength of paperboard used for making paperboard tubes and for making newspaper based on a fixed number of recycle processes and/or mix of virgin pulp, if required.

Referring to FIG. 3, multilayer paperboard 10 components, typically scrap paperboard tube material, are converted to shredded animal bedding material 25 by system 30. Preferably, the multilayer paperboard 10 is compacted prior to being fed into a shredder 12 containing blades that reduce the multilayer paperboard 10 into shredded material 20. A vacuum 16 removes dust created during shredding. Once the multilayer paperboard 10 has been shredded, shredded material 20 is transported to a secondary shredder or grinder 22, by a conveyor 18. Preferably, while on conveyor 18, shredded material 20 is subjected to ultraviolet light 14 by an ultraviolet light source, such as a lamp, which can provide visual evidence of certain kinds of contamination, such as post consumer waste. In addition, ultraviolet light can remove microorganisms from the shredded material 20. Optionally, a sprayer 24 is positioned to spray additives, such as fire retardants and/or disinfectants that resist bacterial growth onto shredded material transported by conveyor 18.

Conveyor 18 transports the shredded material 20 into grinder 22 to further reduce the size of the shredded material 20. Preferably, grinder 22 contains a screen (not shown) to ensure that the size of the shredded material 20 has been reduced to a desired size. During operation of grinder 22, vacuum 16, which is also connected to grinder 22, removes dust from the shredded material 20. Removal of dust from the shredded material 20 is critical for the well-being of animals, especially poultry chicks, which are susceptible to respiratory problems. Such respiratory problems place the animals under stress, potentially increasing mortality rate and reducing the feed conversion rate. Once the shredded material 20 has been sufficiently reduced in size by grinder 22, becoming shredded material 25 as shown in FIG. 4, the shredded material 25 passes through the screen, and is transported a baler 28. Baler 28 compresses an amount of shredded material 25 to a predetermined volume, or bale (not shown) for more efficient transport. Alternately, the loose shredded material 25 can be directed into a vessel and transported without compaction by baler 28.

In an alternate embodiment, shredded newspaper and/or wood chip or other constituents (not shown) can be mixed with the shredded material 25, prior to baling. Preferably, the total percentage volume of the shredded newspaper, wood chip and the like mixture being less than about 50 percent, including any proportion of 49 to 1 percent in one percent increments. Alternately, the mixture of loose shredded material 25 and shredded newspaper and/or wood chip or other constituents can be directed into a vessel and transported without compaction by baler 28.

While multilayer paperboard 10 components can have wall thicknesses of 0.50 inches or more, the shredded material 25 is typically much thinner, with most pieces being several paperboard layers thick. In one embodiment, the screen openings are 1 inch, producing schredded material 25 between about 0.06 inch and about 1.0 inch in either areal direction. In other embodiments, the screen openings are typically range between about ¾ inch and about 1½ inch, producing schredded material 25 between about 0.06 inch and about 1.5 inch in either areal direction, although screen openings significantly outside these ranges can be used, if desired. In other words, it is to be understood that the dimensions of the shredded material 25 can vary, and that the shredder 12 and grinder 22 settings, as well as the mesh size of the screen in the grinder, can be adjusted, as the optimum size and thickness of the shredded material 25 used for smaller animals, such as poultry, may be less than for larger animals, such as horses.

The multilayer paperboard 10 is preferably food grade, including the adhesives or other constituents used in the construction of the multilayer paperboard. Preferably, the paperboard is recycled material, each ply being between about 0.009 inch and about 0.055 inch, although in one embodiment, each ply is between about 0.020 inch and about 0.055 inch. The shredded material 25 obtained from components composed of such multilayer paperboard 10 absorbs the liquid component from animal solid waste and liquid waste better than wood shavings. For the poultry industry, absorbing the liquid waste component reduces the ammonia content in grow houses which decreases the mortality rate of the bird population, reduces the insect populations such as beetles, increases the feed conversion rate and provides overall less stress on the birds. There is a relationship between increased food conversion rate and the stress level on the birds, i.e., as the stress level is reduced, the feeding level increases.

### EXAMPLE

An experiment was performed on two sets of 15 poultry chicks, one set being raised with wood chip bedding material, and the other set being raised with the multilayer bedding material of the present invention. At an age of 36 days, each of the birds was weighed. The average weight of the chicks raised with wood chip bedding material was 2.95 pounds, while the average weight of the chicks raised with the multilayer bedding material was 3.21 pounds. This indicates a weight difference of 0.26 pounds. Extrapolating this difference to the date of bird harvest, it is estimated the birds raised with the multilayer bedding material would weight about 0.75 pounds more than the birds raised with wood chip bedding material. For a grow house containing 15,000 birds, such weight difference would represent an increased yield of 12,000 pounds. Alternately, if the intent was to raise the birds to equivalent weights, the birds raised with the multilayer bedding material would reach the desired weights earlier, saving feed/ventilation costs.

Preferably, the shredded material 25 is applied over the floor of an animal holding structure, such as a poultry growing house, to a depth of between about two inches and about seven inches. Alternately, shredded newspaper and/or wood chip or other constituents can be mixed with the shredded material 25, if desired, preferably the total percentage volume of the shredded newspaper, wood chip and the like mixture being less than about 50 percent, including 49 to 1 percent in one percent increments. As applied for use as bedding material, the term shredded material is understood to include both shredded material 25 and a mixture of shredded material 25 and other materials. It is also to be understood that different application depths of shredded material 25 may be desirable for different animals, or even for the same animals, by different growers. As the application depth of the shredded material 25 is increased, the useful life of the application of the animal bedding is also increased. In other words, a single application of an increased depth of animal bedding material can effectively last for several cycles of animal production, in which additional partial applications of shredded material can be added as needed, such as to areas having a concentration of animal waste.

After the shredded material 25 has been used for animal bedding for a predetermined period of time, i.e., subjected to waste produced by the animals, the bedding can be collected and then used for fertilizer and tilled into the soil. The amount of time the shredded material 25 is to be left on the floor of an animal holding structure can depend upon the size of the animal, the amount of shredded material 25 applied per square foot, as well as other factors, including the possibility that additional bedding material can be added to the originally distributed animal bedding material, or that a mixture of other bedding materials, as discussed previously, is applied. The shredded material 25 releases nitrogen into the soil more slowly than wood chips, which provides for a better, more manageable fertilizer. Additionally, due to the shredded material 25 having a higher density than strips of newspaper, the shredded material is much more likely not to be “blown around,” and also unlike newspaper strips, the shredded material will not festoon fences and trees.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An absorbent animal bedding material, comprising loose, shredded nonfluted multilayer paperboard that is resistant to compaction.

2. The bedding material of claim 1 wherein the paperboard layers are between about 0.009 inch and about 0.055 inch.

3. The bedding material of claim 1 wherein the paperboard layers are between about 0.020 inch and about 0.055 inch.

4. The bedding material of claim 1 wherein the paperboard, upon shredding, is substantially sized between 0.06 inch and 1.5 inch.

5. The bedding material of claim 1 wherein the paperboard, upon shredding, is substantially sized between 0.06 inch and 1.0 inch.

6. The bedding material of claim 1 wherein at least a portion of the paperboard is recycled.

7. The bedding material of claim 1 wherein the paperboard comprises about 50 percent by volume when combined in a mixture of at least one of shredded and ground paper.

8. The bedding material of claim 1 wherein the paperboard is of food quality.

9. The bedding material of claim 1 wherein the paperboard comprises at least one angle member.

10. The bedding material of claim 1 wherein the paperboard comprises at least one tube member.

11. The bedding material of claim 1 wherein the paperboard comprises at least one core member.

12. (canceled)

13. (canceled)

14. (canceled)

15. (canceled)

16. (canceled)

17. (canceled)

18. (canceled)

19. (canceled)

20. (canceled)

21. The bedding material of claim 1 the paperboard is substantially dust free.

22. The bedding material of claim 1 wherein the paperboard is in the form of a bale.

23. The bedding material of claim 1 wherein the nonfluted multilayer paperboard is combined with a proportion of at least one of shredded newspaper, fluted multilayer paperboard, and wood chip.

24. The bedding material of claim 1 wherein the paperboard is an ultraviolet light radiated material.

25. The bedding material of claim 1 comprises additives.

26. The bedding material of claim 25 wherein the additives include at least one of fire retardant and disinfectants.

27. The bedding material of claim 1 wherein shredded paperboard has a reduced size.

28. The bedding material of claim 1 wherein the material is capable of fertilizing plants subsequent to use as animal bedding for a predetermined time.

29. The bedding material of claim 1 wherein the material is tillable into soil.
